(19) United States
(12) Patent Application Publication
(10) Pub. No.: US 2012/0137683 A1
(43) Pub. Date: Jun. 7, 2012

(54) RUN-UP METHOD FOR A SOLAR STEAM POWER PLANT

(76) Inventors: Birnbaum Jürgen, Nurnberg (DE); Markus Fichtner, Wolframs-Eschenbach (DE); Mark Reissig, Ruckersdorf (DE); Marc Sattelberger, Nurnberg (DE)

(21) Appl. No.: 13/379,699

(22) PCT Filed: Jun. 21, 2010
(86) PCT No.: PCT/EP2010/058720

§ 371 Date: Dec. 21, 2011

Related U.S. Application Data
(60) Provisional application No. 61/220,691, filed on Jun. 26, 2009.

(51) Int. Cl. F03G 6/00; F01K 3/00; F01K 13/02

(52) U.S. Cl. 60/641.8; 60/646; 60/656; 60/659

(57) ABSTRACT

A run-up method for a solar steam power plant is proposed. In the run-up method an auxiliary steam is used to generate seal steam for a steam-turbine of the power plant. The auxiliary steam is produced by a heat-exchanger-system that is to provide, during a subsequent power-mode, overheated steam for driving the steam-turbine.

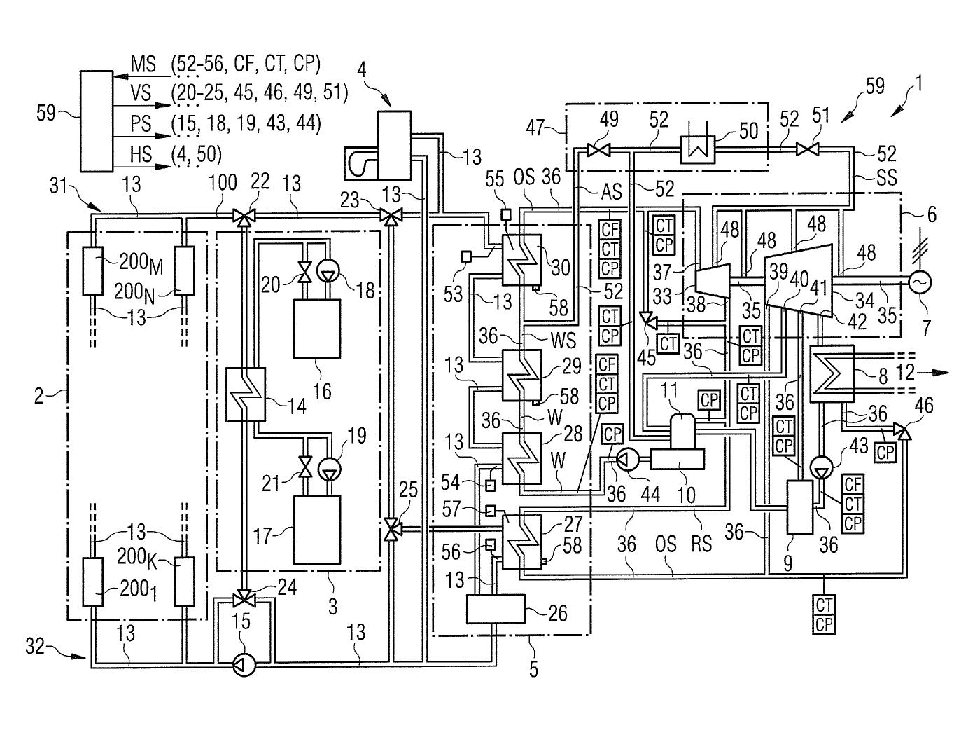

### CROSS REFERENCE TO RELATED APPLICATIONS

This application is the US National Stage of International Application No. PCT//EP2010/058720, filed Jun. 21, 2010 and claims the benefit thereof. The International Application claims the benefits of a provisional patent application filed on Jun. 26, 2009, and assigned application No. 61/220,691. Both of the applications are incorporated by reference herein in their entirety.

### FIELD OF THE INVENTION

The invention relates to a run-up method for a solar steam power plant, the method comprises the step of using auxiliary steam to generate sealing-steam for a steam turbine of the solar steam power plant. The invention also relates to a solar steam power plant that comprises a steam turbine, which requires seal steam to seal its shaft. The invention also relates to a control unit for a solar steam power plant.

### BACKGROUND OF THE INVENTION

In a common steam power plant a heating-section that comprises a power-steam-generator is thermally coupled via a heat-exchanger-system with a power-block. In the power-steam-generator the heat generated by burning fossil fuel is used in the heat-exchanger-system to evaporate water and to generate overheated steam in order to drive a steam turbine in the power-block, which in turn drives a generator to generate electrical power. This operation condition is called the power-mode.

The power-block is a closed loop circuit in which a fluid, e.g. water—often pre-heated—is taken from a feed water tank and pressurized, fed into the heat-exchanger-system where first of all saturated steam is generated. In the heat-exchanger-system the saturated steam is further heated up to generate the overheated steam. The overheated steam is fed into the steam turbine where it relaxes and from where it is guided into a condenser to condense the relaxed steam back into its liquid phase. The water delivered from the condenser is guided back into the feed water tank. The cycle of producing steam from water and converting it back into water is herein termed “water-steam-cycle”.

After the end of an interruption of the power-mode, which means at the end of a standby-mode during which the turbine was not in operation, the power plant must be carefully run-up back into its power-mode. During the run-up phase it is necessary to use auxiliary steam to generate seal steam. The purpose of the seal steam is to maintain the turbine's shaft seal tight. This prevents air to enter into the turbine and the condenser. In practice, saturated auxiliary steam is produced in a separate auxiliary-steam-generator. The saturated-auxiliary steam is than overheated and becomes seal steam. The seal steam is fed into the turbine separately from the overheated steam. Similar to the overheated steam used to drive the turbine also the seal steam is at least partly guided back into the condenser of the power-block.

The existence of the auxiliary steam-generator causes several disadvantages, which are for example additional costs for production, installation and maintenance as well as for operation of it. Typically, each additional component also increases the number of failure sources.

In contrast to a conventional steam power plant operated by fossil fuels, which are rarely put in standby-mode, a solar steam power plant may perform the standby-mode naturally on a daily basis, e.g. during the night. In addition, also cloudy or foggy whether condition may force the activation of the standby-mode during a daylight period. Hence, the auxiliary steam generator will be in operation at least once a day at the end of the night hours or in addition also during the daylight period after the clouds or the fog has disappeared and power-mode shall be restored. The periodical operation of the auxiliary steam-generator has a significant impact on the efficiency of such a solar steam power plant. Also the relative high frequency of use of the auxiliary steam generator when compared with the frequency of use in a conventional steam power plant has an impact on the lifetime of the auxiliary steam generator, which in turn has a negative economical impact on the operation and/or maintenance costs of the entire solar steam power plant.

### SUMMARY OF THE INVENTION

It is an object of the invention to provide an improved run-up method for a solar steam power plant, an improved solar steam power plant and an improved control unit for a solar steam power plant.

The object of the invention is achieved by a run-up method for a solar steam power plant and a solar steam power plant as well as a control unit for a solar steam power plant according to the claims.

According to the invention the run-up method for a solar steam power plant comprises the step of using auxiliary steam to generate seal steam for a steam turbine of the power plant, wherein the auxiliary steam is produced by a heat-exchanger-system that is realized to provide, during a subsequent power-mode, overheated steam for driving the steam turbine.

The solar steam power plant according to the invention comprises a heating-section to heat a heat-transfer fluid, and a steam turbine that utilizes overheated steam produced during a power-mode to drive a generator to generate electricity, and a heat-exchanger-system connected between the heating-section and the steam turbine for generating said overheated steam for the steam turbine by the aid of the heat stored in the heat-transfer fluid, and an auxiliary-steam-system for generating seal steam to seal a shaft of the steam turbine, said auxiliary-steam-system is connected at its output to the steam turbine and at its input to the heat-exchanger-system to use the steam available at the heat-exchanger-system as auxiliary steam for generating said seal steam.

According to the invention the control unit for a steam power plant is designed to control the use of the steam of the heat-exchanger-system for the production of the seal steam to seal a shaft of a steam turbine of the solar steam power plant.

Advantageously a separate auxiliary-steam-generator as a source of saturated steam as auxiliary steam is avoided. Instead of the auxiliary-steam-generator the heat-exchanger-system is used as a source to supply steam as auxiliary steam that in turn is used in the auxiliary-steam-system according to the invention to create the seal steam for the steam turbine.

Herein the teen “power-mode” shall mean that mode of operation of the solar steam power plant in which a primary source of energy, which is the sunlight, causes overheated/superheated steam to be produced for driving the steam turbine in order to generate electrical power. This is sometimes also termed power generation operation or power generation mode.

The term “standby-mode” shall mean that mode of operation of the solar steam power plant, in which the primary source of energy is not used to cause overheated steam to be produced to drive the steam turbine. During the standby-mode typically some components of the solar steam power plant still need to be in operation for various reasons, e.g. to allow a rapid re-start of the power-mode. Hence, sometimes not the entire plant is put out of operation. Only the power generation is temporary switched off or interrupted for a period.

The term “run-up mode” shall mean that mode of operation of the solar steam power plant, in which the solar steam power plant is driven back into its power-mode. In this run-up mode the run-up method according to the invention is applied.

In a solar steam power plant the power-steam-generator comprises a so termed solar field, in which e.g. mirrors and/or lenses concentrate or focus sunlight onto pipes that guide the heat-transfer fluid. A number of first pipes that guide the heat-transfer fluid are connected to the heat-exchanger-system. These first pipes of the heating section form a first closed loop circuit through which the heat-transfer fluid is circulated.

On the other hand, the power-block is also connected to the heat-exchanger-system via a number of second pipes. The second pipes of the power-block form a second closed loop circuit. In the second closed loop circuit a fluid, e.g. water is heated up in the heat-exchanger-system until it is converted from its liquid phase into saturated steam and finally into overheated steam. During power-mode the overheated steam drives the steam turbine, from where it departs in a relaxed mode and condenses back into the liquid phase in a condenser located downstream with regard to the steam turbine in the second closed loop circuit. The condensate is fed back into a feed water tank that supplies the heat-exchanger-system with said fluid.

The heat-exchanger-system typically comprises a number of heat exchangers that are connected in series with each other in order to heat up water, evaporate water in order to produce the saturated steam and finally to further heat up the saturated steam until dry, so termed overheated or superheated steam is generated. Typically saturated steam is also the starting point for producing seal steam. The auxiliary-steam-system is connected to the respective heat exchanger at the heat-exchanger-system, either via an individual outlet of the heat exchanger or a connection to the pipe departing from this heat exchanger. Hence, that part of the heat-exchanger-system that produces the saturated steam can be used in place of a conventional separate auxiliary-steam-generator known from conventional steam power plants.

The production of saturated steam typically involves a drum type heat exchanger or a once through type heat exchanger or a kettle type heat exchanger in the chain of heat exchangers of the heat-exchanger-system.

At the steam turbine the seal steam generated according to the invention is fed into a turbine's seal-steam-system.

As a consequence of applying the measures according to the invention the following advantages are achieved. The avoidance of a separate auxiliary-steam-generator allows reducing the costs of the solar steam power plant not only in terms of production and/or installation costs but also in terms of maintenance, service and operation costs. Hence a significant cost advantage is achieved. Also the number of failure sources is sustainably reduced. The efficiency of the solar steam power plant is also increased.

Particularly advantageous embodiments and features of the invention are given by the dependent claims and the following description. In particular the steam power plant as well as the control unit according to the invention may be further developed according to the dependent claims of the run-up method and advantages elaborated in the context of the run-up method claims do apply as well for the steam power plant and the control unit claims.

According to one aspect of the invention, in case of a run-up with a cold condition of the heat-transfer fluid in the heat-exchanger-system, a heating source is used to rise the temperature of a heat-transfer fluid for a pre-determined duration and a flow of the heat-transfer fluid through the heat-exchanger-system is controlled with regard to pressure and quantity (mass flow) until a pre-determined auxiliary steam pressure is reached in the heat-exchanger-system. Typically the pre-determined duration is in the range of one hour during which the heater, e.g. a gas-fired heater acting as said heating source, is in operation to increase the temperature of the heat-transfer fluid. However, dependent on the actual design of the steam power plant the pre-determined duration may also deviate from this exemplary value. This allows starting the entire run-up method even from a cold condition of the heat-transfer fluid. In case of oil as a heat-transfer fluid, the gas-fired heater can be used to prevent the oil from coagulating. As the heat-transfer fluid is heated up and fed through the heat-exchanger-system, the heater is in fact used to indirectly feed the water-steam-cycle via the heat-exchanger-system with heat.

According to another aspect of the invention during standby-mode auxiliary steam is kept under a pre-determined auxiliary steam pressure in a drum-type heat exchanger of the heat-exchanger system and a flow of the heat-transfer fluid through the heat-exchanger-system is controlled with regard to pressure and quantity (mass flow) such that a predetermined auxiliary steam pressure is maintained. This aspect provides the advantage that the steam turbine can be permanently supplied with the required seal steam during the standby-mode, e.g. during the night or when the sun light is not sufficient bright because of cloudy, rainy or even foggy whether conditions. This aspect of the invention is based on the insight that the quantity of saturated auxiliary steam that can be stored in the drum-type heat exchanger is sufficient to supply the required amount of seal steam per unit of time to the shaft seal of the steam turbine during a longer standby-mode, e.g. during the night. By means of this feature the shaft seal can be kept permanently tight during longer power-mode interruptions without the necessity of a separately produced auxiliary steam. Hence, in a relatively simple and efficient manner the lifetime of the turbine is prolonged and as a consequence also costs are reduced. Also the run-up duration of the steam power plant is faster when compared with the preceding aspect because the auxiliary steam already exists in the heat-exchanger-system and therefore does not need to be produced before the use of the auxiliary steam may start.

In a solar steam power plant it is also possible to use a solar field of the solar steam power plant as a heat-injecting heating-source for heating up the heat-transfer fluid in order to perform the run-up mode.

According to a structural aspect of the invention the solar steam power plant comprises a thermal storage, in particular in form of a tank system that contains a molten salt, for storing heat provided by the heat transfer fluid, wherein the thermal storage is used to generate said steam in the heat-exchanger-system and/or to maintain the availability of the steam at the heat-exchanger-system. In case of a e.g. salt tank system as a thermal storage for storing a molten salt in a hot condition, it is also possible to use the heat stored in the molten salt to run-up the solar steam power plant. In such a configuration of the solar steam power plant a separate salt-HTF heat exchanger is used during the day to heat up the molten salt, which is stored in its hot condition in the salt tank system. During the night the heat stored by the molten salt can be used to heat up the heat transfer fluid via said separate salt-HTF heat exchanger. The heated up heat-transfer fluid is than used to transfer the heat into the water-steam-cycle via the heat-exchanger-system in order to perform the run-up mode or even to perform the power-mode after the run-up mode is completed during the night.

For both preceding aspects of optional heating-sources (use of solar field or use of thermal storage), the energy efficiency of the plant is also increased because the use of the sunlight or the use of the stored heat in the molten salt is more efficient than in the case of the generation of auxiliary steam from a cold liquid, as would be the case if a separate auxiliary steam generator or a gas-fired heater were used.

According to a further aspect of the run-up method the control of the pressure is set such that the pressure of the heat transfer fluid is above the vapour pressure of the heat-transfer fluid but still be kept at a sufficiently low level such that, in case of a leakage in the heat-exchanger-system, the amount of heat-transfer fluid that may enter into the water-steam-cycle is kept at a minimum. As during this phase the pressure of the heat transfer fluid is higher than the pressure of the water-steam-cycle in the heat-exchanger-system, it may happen that the heat transfer fluid penetrates into the water-steam-cycle in the heat-exchanger-system, e.g. via small cracks in a pipe system of the heat-exchanger-system. Such a leakage should be avoided.

Preferably during the run-up method said leakage of the heat-transfer fluid into the water-steam-cycle needs to be checked. The leakage check is based on conductivity measurements of the fluid available at the sampling lines of the heat-exchanger-system or may be performed by means of a carbon based detector that utilizes said fluid to detect leakage. Therefore, as soon as liquid is available at the sampling lines in the heat-exchanger-system, which means that sampling lines respond, a leakage of the heat-transfer fluid into the heat-exchanger-system is monitored, wherein the leakage monitoring is maintained until the pressure of the steam in the heat-exchanger-system rises above the pressure of the heat-transfer fluid, and, in case of a detected leakage, a trip-out (or emergency shut-down) is performed. The trip-out prevents the penetration of further heat-transfer fluid into the water steam cycle, which in turn avoids pollution of the water steam cycle.

Before the steam generated by the auxiliary-steam-system can be used as seal steam it must reach a certain pressure level. Consequently, the steam turbine is fed with said seal steam after a pre-determined steam pressure is reached. Also the evacuation of a condenser starts at that time.

In the following, as soon as a pre-determined vacuum level is reached in the condenser, bypass sections, e.g. low-pressure and high-pressure but also medium-pressure bypass sections—if available—of the steam turbine are enabled. This does not mean that the bypass sections are opened. Rather more the bypass sections are made ready to be opened. Steam turbine valves are closed, hence it is avoided that saturated (wet) steam enters into the turbine.

Thereafter, the amount of heat transferred into the water-steam-cycle by the heat-exchanger-system is increased under temperature control, e.g. constant temperature, until the steam pipes of the power block and the steam turbine have warmed sufficiently. “Have warmed sufficiently” shall mean to have reached a temperature difference above a saturation temperature of the steam of approximately more than 60K between a high-pressure turbine output and a solar re-heater (also termed “cold re-heating”) and/or more than 40K between the solar re-heater and a low-pressure turbine input (also termed “hot re-heating”). The saturation temperature is defined by the actual pressure of the steam. After this is achieved the bypass sections of the steam turbine are opened such that the steam can bypass the steam turbine, while the steam turbine valves are still closed.

The bypassing steam is used to increase the pressure in the solar and low-pressure re-heater. After a minimum pressure in the re-heater is reached, a de-aerator is put in operation and a pressure in a feed water tank is increased. The de-aerator can be a separate device but may also be incorporated in the feed-water-tank. The latter solution may be realized by a so termed “spray de-aerator”.

Thereafter, the quality of the steam to be used for driving the steam turbine is successively increased, which means that the amount of water in the steam is reduced. After an appropriate quality of the steam is achieved, which means dry overheated steam is generated with a sufficient quantity and pressure, the steam turbine is put in operation and ramped up under temperature and pressure control until it reaches its base load of 100%.

According to a further structural aspect of the invention the auxiliary-steam-generator comprises a pressure-reducing valve at its input for reducing the pressure of the auxiliary steam received from the heat-exchanger-system. This allows reducing the amount of auxiliary steam taken from the heat-exchanger-system such that only the required amount is extracted per unit of time. Hence a highly efficient use of the auxiliary steam that is either stored in the heat-exchanger-system—if it comprises a drum-type design where the steam can be stored—or produced in the heat-exchanger-system if it comprises either a drum type design or a once-through-type design or a kettle type design—is provided.

The auxiliary-steam-system also comprises a heater for superheating the saturated auxiliary steam to produce seal steam. The heater may be realized as a fossil fuel burning heater. In a preferred embodiment an electric heater is provided because the power of such a heater is easier to control and the desired heat can be more efficient achieved.

According to a further aspect of the invention a bypass pipe section is provided between the auxiliary-steam-system and a feed fluid tank (in the following named “feed water tank”) to bypass the steam turbine. This bypass pipe section is preferably connected with the pipe that connects the pressure-reducing valve with the heater of the auxiliary-steam-system and allows to maintain or even to increase the pressure in the feed water tank by the use of the auxiliary steam.

### BRIEF DESCRIPTION OF THE DRAWINGS

Other objects and features of the present invention will become apparent from the following detailed descriptions considered in conjunction with the accompanying drawing. It is to be understood, however, that the drawing is designed solely for the purposes of illustration and not as a definition of the limits of the invention.

FIGURE shows an embodiment of a solar steam power plant according to the invention.

### DETAILED DESCRIPTION OF THE INVENTION

In this FIGURE a solar steam power plant is schematically depicted, which is termed plant 1 in the following. In this plant 1, during power-mode, solar energy is converted into electrical power.

The plant 1 comprises a solar field 2, a thermal storage 3, a gas heater 4, a heat-exchanger-system 5, a steam turbine 6, an electrical generator 7, a condenser 8, a low-pressure pre-heater 9, a feed water tank 10 with a de-aerator 11, and a cooling section 12, which is connected to the condenser 8, but not shown in details because it is not concerned in the present context.

The solar field 2 comprises a number of lenses and/or mirrors 200₁ to 200_{N} that focus the sunlight on a number of first pipes 13 that convey a heat transfer fluid—in the following abbreviated HTF 100—in order to heat up the HTF 100. The HTF 100 is thermo-oil but other fluids, e.g. molten salt, may also realize it. The first pipes 13 are connected to the thermal storage 3 and the heat-exchanger-system 5. The first pipes 13 realize a first closed loop circuit for the HTF 100 through the solar field 2 and the heat-exchanger-system 5. The first pipes 13 also allow the thermal storage 3 to participate in the circulation of the HTF 100, which is driven by a first pump 15.

The thermal storage 3 comprises a salt-HTF heat exchanger 14 to exchange the heat stored in the HTF 100 with a molten salt that is stored in two salt tanks, of which a first salt tank 16 is dedicated to store hot molten salt and a second salt tank 17 is dedicated to store cold molten salt. In the present context the term “hot” indicates a typical temperature range from 380° C. to 400° C. and the term “cold” indicates a typical temperature range from 280° C. to 300° C. Dependent on the fact whether the HTF 100 receives heat from the molten salt or the HTF 100 transfers heat into the molten salt the flow of salt between the two tanks 16 and 17 is controlled by the aid of a second pump 18, a third pump 19, a first valve 20 and a second valve 21. Instead of the molten salt also other heat storage media may be used.

In order to control pressure, temperature and/or mass flow of the HTF 100 in the various sections of the first pipes 13 a third valve 22, a forth valve 23, a fifth valve 24 and a sixth valve 25 is provided at locations a shown in FIGURE.

The heat-exchanger-system 5 comprises an expander vessel 26, a solar re-heater 27, a solar pre-heater 28, a solar steam-generator 29 and a solar super-heater 30. The expander vessel 26 may also be located outside of the heat-exchanger-system 5. The solar steam-generator 29 is of the drum-type design. With regard to the flow of the HTF 100 from a so termed hot pipe header 31 to a cold pipe header 32 the solar super-heater 30 and the solar steam-generator 29 and the solar pre-heater 28 are installed in series connection. The solar re-heater 27 is connected in parallel connection thereto. The HTF 100 departing from the solar pre-heater 28 as well as the HTF 100 departing from the solar re-heater 27 is fed into the expansion vessel 26.

Also connected between the hot pipe header 31 and the cold pipe header 32 is the HTF gas heater 4, which is designed to heat up the HTF 100 by means of a gas. This prevents the HTF 100 from coagulation in case of low temperatures. In the present context the term “low” indicates a temperature range below 15° C., wherein in the present case 15° C. is the temperature threshold for coagulation.

The steam turbine 6 comprises a high-pressure section 33 and a low-pressure section 34. A shaft 35 of the steam turbine 6 is put in rotation and drives the electrical generator 7 if sufficient overheated steam OS (sometimes also termed superheated steam) is supplied to the steam turbine 6. The shaft rotation may also be driven via a gear unit or the like.

The heat-exchanger-system 5, the steam turbine 6, the condenser 8, the low-pressure pre-heater 9 and the feed water tank 10 and the de-aerator 11 are connected by a number of second pipes 36. By means of these second pipes 36 the following parts are connected with each other.

An output of the solar super-heater 30 is connected to a high-pressure turbine input 37. A high-pressure turbine output 38 is connected to an input of the solar re-heater 27 and an output of the solar re-heater 27 is connected with a low-pressure turbine input 39. A first low-pressure turbine output 40 is connected to the de-aerator 11. A second low-pressure turbine output 41 is connected to the low-pressure pre-heater 9.

It is to mention that the low-pressure pre-heater 9 is typically realized with three stages (not depicted in details). These stages are connected in series and each of these stages has its individual connection (individual second low-pressure turbine output 41) with the low-pressure section 34.

A third low-pressure turbine output 42 (sometimes termed “turbine exhaust”) is connected to the condenser 8. The condenser 8 is also connected with the low-pressure pre-heater 9 via a fourth pump 43. The low-pressure pre-heater 9 is connected with the de-aerator 11. The feed water tank 10 is connected via a fifth pump 44 with an input of the solar pre-heater 28. Although not depicted in the FIGURE there are typically two high-pressure pre-heaters connected in series to each other and located downstream to the solar pre-heater 28 and upstream to the fifth pump 44 connected with an individual connection to the high-pressure section 33 and to one of the second pipes 36 connecting the high-pressure turbine output 38 and the solar re-heater 27.

The high-pressure turbine input 37 is connected to the high-pressure turbine output 38 via a high-pressure bypass valve 45 and the low-pressure turbine input 39 is connected to the condenser 8 via a low-pressure bypass valve 46. The number of second pipes 36 and the elements connected by it realize a second closed loop circuit for circulation of the water W either in its liquid phase or in its steam phase WS, OS, AS or SS.

The plant 1 also comprises an auxiliary-steam-system 47, which is connected at its inlet to the heat-exchanger-system 5, in particular to the outlet of the solar steam-generator 29. At its output the auxiliary steam system 47 is connected to a number of seal-steam inputs 48 of the steam turbine 34. The auxiliary steam system 47 uses saturated steam WS taken from the solar steam-generator 29 to produce the seal steam SS for the steam turbine 6. At its input the auxiliary-steam-system 47 comprises a pressure-regulating valve 49 followed by an electrical super heater 50 that further heats up the auxiliary steam such that the seal steam SS is created as overheated/superheated auxiliary steam AS, which is released to the seal-steam inputs 48 via a further valve 51. A number of third pipes 52 connect the elements 29, 49, 50, 51 and 48, as well as the element 49 and 10 and/or 11 with each other.

During power-mode the sun heats up the HTF 100 in the solar field 2. The HTF 100 circulates through the number of first pipes 13. At the heat-exchanger-system 5 the heat stored in the HTF 100 is used to produce steam WS, AS and OS from the water W stored in the feed water tank 10. The water W is pre-heated at the solar pre-heater 28. At the solar steam-generator 29 saturated steam WS is produced from the pre-heated water W. Based on the saturated steam WS overheated or superheated steam OS is produced at the solar super heater 30, which is fed into the steam turbine 6 via the high-pressure turbine input 37. From the high-pressure turbine output 38, relaxed steam RS is fed into the solar re-heater 27 where it is re-heated to be converted once more into overheated steam OS, which is fed into the low-pressure turbine input 39. From the low-pressure section 34 the used steam departs via the first low-pressure turbine output 40 to the de-aerator 11, from the second low-pressure turbine output 41 to the low-pressure pre-heater 9 from where it is fed into the de-aerator 11 and from the third low-pressure turbine output 42 to the condenser 8 from where water W is fed into the low-pressure pre-heater 9 and finally supplied to the de-aerator 11.

During the power-mode a heat storage operation is performed, in which hot HTF 100 also flows through the salt-HTF heat exchanger 14 while cold molten salt is pumped from the second salt tank 17 into the first salt tank 16, where the molten salt that is heated up in the salt-HTF heat exchanger 14 is stored for later use.

The plant 1 further comprises a number of measurement systems of which some are indicated in FIGURE. A first measurement system 53 is located close to the solar super heater 30 to measure temperature, pressure, and mass flow (through put) of the HTF 100 by means of three measurement devices (not depicted) at three different locations positioned closely to each other. A second measurement system 54 is located close to the solar pre-heater 28 to measure temperature at three locations and pressure of the HTF 100. A third measurement system 55 is located in the solar super heater 30 to measure the pressure of the HTF 100 in the solar super heater 30. A fourth measurement system 56 is located close to the solar re-heater 27 to measure temperature and mass flow (though put) of the HTF 100. A fifth measurement system 57 is located in the solar re-heater 27 to measure temperature and pressure of the HTF 100 in the solar re-heater 27. The FIGURE also shows a number of further measurement devices and/or systems located at various positions within the plant 1 and labelled as CF for measuring throughput, CP for measuring pressure and CT for measuring temperature. The aforementioned group of two high-pressure pre-heaters (not depicted) has such a measurement device/system (labelled as block CP) at its input and a measurement device/system (labelled as block CF, CT, CP) at its output as schematically indicated between the fifth pump 44 and the solar re-heater 28.

The plant 1 also comprises a control unit 59 that receives measurement signals MS from the measurement systems 53 to 57 and CF, CP and CT. The control unit 57 uses these measurement signals MS and further information not depicted in details to control and/or to decide about its mode of operation and in particular to control a run-up mode according to the run-up method of the invention. In this context it supplies valve control signals VS to the valves 20-25, 45, 46, 49 and 51 in order to control the settings of these valves, pump control signals PS to the pumps 15, 18, 19, 43 and 44 in order to control the operation of these pumps, and heater control signals HS to the heaters 4 and 50 in order to control the operation of these heaters. The control unit 59 also controls further components of that part of the plant 1 that is depicted in FIGURE but not elaborated in details. Also components that are not depicted in FIGURE are controlled by the control unit 57, e.g. those of the cooling section 12.

In general, during the standby-mode the generation of overheated steam OS by the sun, which overheated steam OS drives the steam turbine 6, is disrupted. However, due to the heat stored in the first salt tank 16 the generation of overheated steam OS used to drive the steam turbine 6 can be continued for a certain period during which the intensity of the sun light does not suffice for the generation of the overheated steam OS. During this period the hot molten salt is pumped from the first salt tank 16 into the second salt tank 17 and heats up the HTF 100 while it passes through the salt-HTF heat exchanger 14.

In case of a longer interruption of the power-mode, so to say during a longer standby-mode, the generation of overheated steam OS to drive the steam turbine 6 is interrupted as well as the operation of the steam turbine 6. All elements dedicated to the water-steam-cycle including in particular the steam turbine 6 and the second pipes 36 cool down during this period.

Now, in order to restart the power-mode a run-up mode needs to be initiated and performed in which a method according to the invention is executed, which is described in the following and controlled by the control unit 59.

In the present scenario it is assumed that the solar steam-generator 29 still holds saturated steam WS under sufficient pressure in its drum to immediately start the supply of auxiliary steam AS to the auxiliary-steam-system 47. In order to maintain the pre-determined auxiliary steam pressure while auxiliary steam AS is supplied into the auxiliary-steam-system 47 the flow of the heat-transfer fluid HTF 100 through the heat-exchanger-system 5 is controlled with regard to pressure and quantity. During this initial phase the supply of heat into the HTF 100 is provided either by the solar field 2 or by the thermal storage 3, wherein the selection of the source (solar field, molten salt) for injecting heat into the HTF 100 is mainly dependent on the environment condition (sun light: daylight hours; no sunlight: daylight hours but cloudy condition or night hours) and/or the duration of the standby-mode. Dependent on the amount of heat required it is also possible to use the HTF gas heater 4 to inject heat into the HTF 100.

Steam turbine valves (not depicted) which control the inflow and outflow of steam at the high-pressure turbine input 37 and the high-pressure turbine output 38 but also at the low-pressure turbine input 39 and the low-pressure turbine output 42 are closed in order to avoid any penetration of wet saturated steam WS into the steam-turbine 6.

During this initial phase the control of the pressure is set such that the pressure of the HTF 100 is above the vapour pressure of the HTF 100 but still be kept on such a low level that in case of a leakage in the heat-exchanger-system 5 the amount of HTF 100 that may enter into the water or steam guiding section of heat-exchanger-system 5 is kept on a minimum level before it can be detected. As soon as sampling lines 58 in the heat-exchanger-system 5 respond, which means that liquid is detected at the sampling lines 58, a leakage of the HTF 100 into the heat-exchanger-system 5 is checked, wherein the leakage check is maintained until the steam and/or water pressure in the heat-exchanger-system 5 rises above the pressure of the HTF 100, which means that leakage of the HTF 100 into the water W and/or steam WS, OS may not take place any more because of the counter-pressure of the water W and/or steam WS or OS. In case of a detected leakage a trip-out is performed for protection of the plant 1 and the environment and human beings.

The auxiliary steam AS taken from the solar steam-generator 29 in form of saturated steam WS is electrically overheated by the electrical super heater 50 in the auxiliary-steam-system 47 and the steam turbine 6 is fed via the seal-steam inputs 48 with said seal steam SS after a pre-determined steam pressure is reached. Also the evacuation of a condenser 8 starts.

From the auxiliary steam system 47 the auxiliary steam AS is also supplied to the feed water tank 10 via the pipe departing from the auxiliary-steam-system 47 between the pressure reducing valve 49 and the electrical super heater 50. This allows to maintain a required pressure level or to increase the pressure level in the feed water tank 10.

Until now not only the steam turbine valves but also the high-pressure bypass valve 45 and the low-pressure bypass valve 46 are closed. The second pipes 36 connected to the bypass valves 45 and 46 and the two bypass valves 45 and 46 are termed turbine bypass sections. As soon as a pre-determined vacuum level is reached in the condenser 8 the turbine bypass sections of the steam turbine 6 are enabled, which means that from here on they can be opened. In the following the amount of heat over the heat-exchanger-system 5 is increased under temperature control, which means that the temperature is kept constant, until the second steam-pipes 36—in particular those second steam-pipes 36 connecting the solar super-heater 30 with the high-pressure section 33 and the high-pressure bypass valve 45, the high-pressure section 33 and the high-pressure bypass valve 45 with the solar re-heater 27, and the solar re-heater 27 with the condenser 8—and the steam turbine 6 are warm. The warming up is achieved by the aid of separate warming up/pre-heating pipes, which are not depicted in the FIGURE.

Thereafter the turbine bypass sections are opened and the steam bypasses the steam turbine 6, while the steam turbine valves are still closed.

Now the steam flows from the high-pressure valve 45 to the solar re-heater 27 and from there to the low-pressure valve 46, through the low-pressure pre-heater 9 and into the de-aerator 11. Once a minimum pressure in the solar re-heater 27 is reached, the de-aerator 11 is put into operation and the pressure in the feed water tank 10 is increased. Now, while maintaining a constant mass-flow of the HTF 100, the HTF 100 temperature is increased with a constant rate up to 393° C. Until now the turbine bypass sections are still open.

Once an appropriate quality of the steam is reached, which means that overheated/superheated steam OS is produced, the steam turbine valves are opened in a controlled manner under control of the control unit 59 and the steam turbine 6 is put in operation and ramped up under temperature and pressure control. During the controlled opening of the steam turbine valves mass flow and temperature of the HTF 100 are constant, the steam turbine 6 is supplied with overheated steam OS while the high-pressure bypass valve 45 and the low-pressure bypass valve 46 are slowly closed, each of the valves 45 and 46 being under individual control of the control unit 59. By continuously increasing the amount of overheated steam OS to flow through the steam turbine 6, while reducing the flow through the bypass section, power of the steam turbine 6 is ramped up to base load (100% power) with constant HTF 100 temperature but increased mass flow of the HTF 100.

In a further scenario it is assumed that there is non-sufficient pressure of saturated steam WS in the drum of the solar-steam generator 29 or no steam at all is stored in the solar-steam generator 29. Consequently the immediate start of the supply of auxiliary steam AS to the auxiliary-steam-system 47 is not possible.

Therefore, first of all, heat needs to be supplied into the HTF 100. This may be achieved e.g. by the solar field 2 or the thermal storage 3. However, in the present scenario the gas heater 4 is used to rise the temperature of the HTF 100 for a pre-determined duration, e.g. 1 hour before the use of the auxiliary steam AS can be started, and a flow of the HTF 100 through the heat-exchanger-system 5 is controlled with regard to pressure and quantity (mass flow), e.g. kept constant, until a pre-determined auxiliary steam AS pressure is reached in the heat-exchanger-system 5. From here on the run-up method according to the invention can be executed as described in the preceding scenario. The use of the gas heater 4 during the initial phase of the run-up method is of particular advantage as it must be operated anyhow if the HTF 100 becomes too cold in order to avoid coagulation in the HTF 100.

If—according to a further embodiment—a once through type heat exchanger is used, the saturated auxiliary steam AS can be extracted at the output of the element indicated with reference 30 in the heat-exchanger-system 5, so to say at the output of the heat-exchanger-system 5.

For the sake of clarity, it is to be understood that the use of “a” or “an” throughout this application does not exclude a plurality, and “comprising” does not exclude other steps or elements. A “unit” or “module” can comprise a number of units or modules, unless otherwise stated.

1.-17. (canceled)

18. A run-up method for a solar steam power plant, comprising:
producing an auxiliary steam by a heat-exchanger-system that is used to provide an overheated steam for driving a steam turbine of the solar steam power plant during a power-mode; and
generating seal steam for the steam turbine using the auxiliary steam.

19. The method as claimed in claim 18,
wherein a temperature of a heat-transfer fluid in the heat-exchanger-system is raised by a heat source for a predetermined duration if the solar steam power plant is run-up with a cold condition of the heat-transfer fluid, and
wherein a flow of the heat-transfer fluid through the heat-exchanger-system is controlled with regard to a pressure and quantity until a pre-determined auxiliary steam pressure is reached in the heat-exchanger-system.

20. The method as claimed in claim 18,
wherein the auxiliary steam is kept under a pre-determined auxiliary steam pressure in a drum-type heat exchanger of the heat-exchanger-system during a standby-mode, and
wherein a flow of a heat-transfer fluid through the heat-exchanger-system is controlled with regard to a pressure and quantity to maintain the pre-determined auxiliary steam pressure.

21. The method as claimed in claim 20,
wherein the pressure of the heat-transfer fluid is controlled to be greater than a vapour pressure of the heat-transfer fluid, and
wherein the quantity of the heat-transfer fluid entering into water and/or steam in the heat-exchanger-system is controlled at a minimum if a leakage of the heat-transfer fluid occurs in the heat-exchanger-system.

22. The method as claimed in claim 18,
wherein a leakage of a heat-transfer fluid in the heat-exchanger-system is monitored,
wherein the leakage is monitored until a pressure of water and/or steam in the heat-exchanger-system rises above a pressure of the heat-transfer fluid, and
wherein a trip-out is performed if the leakage is detected.

23. The method as claimed in claim 18, wherein the steam turbine is fed with the seal steam after a pre-determined steam pressure is reached and a condenser starts evacuation.

24. The method as claimed in claim 18, wherein bypass sections of the steam turbine are enabled when a pre-determined vacuum level is reached in a condenser.

25. The method as claimed in claim 18, wherein amount of heat transferred by the heat-exchanger-system is increased under temperature control until steam pipes and the steam turbine have warmed sufficiently and bypass sections of the steam turbine have opened.

26. The method as claimed in claim 18, wherein a de-aerator starts operation and a pressure in a feed-water-tank is increased when a minimum pressure in a solar re-heater has been reached.

27. The method as claimed in claim 18, wherein the steam turbine starts operation and is ramped up under temperature and pressure control when the overheated steam has reached an appropriate quality.

28. A solar steam power plant, comprising:
a heating-section to heat a heat-transfer fluid;
a steam turbine utilizing an overheated steam produced during a power-mode to drive a generator for generating electricity;
a heat-exchanger-system connected between the heating-section and the steam turbine for generating the overheated steam; and
an auxiliary-steam-system connected between the steam turbine and the heat-exchanger-system for generating a seal steam to seal a shaft of the steam turbine using the overheated steam at the heat-exchanger-system as an auxiliary steam.

29. The solar steam power plant as claimed in claim 28, wherein the auxiliary-steam-system comprises a pressure-reducing valve at input for reducing a pressure of the auxiliary steam received from the heat-exchanger-system.

30. The solar steam power plant as claimed in claim 28, wherein the auxiliary-steam-system comprises a heater for heating the auxiliary steam to produce the seal steam.

31. The solar steam power plant as claimed in claim 28, wherein the auxiliary-steam-system is connected to a feed fluid tank by a bypass pipe for bypassing the steam turbine.

32. The solar steam power plant as claimed in claim 28, further comprising a control unit for controlling a production of the seal steam using the overheated steam of the heat-exchanger-system.

33. The solar steam power plant as claimed in claim 28, further comprising a thermal storage system for storing heat provided by the heat transfer fluid, wherein the thermal storage system generates the overheated steam in the heat-exchanger-system and/or maintains an availability of the overheated steam at the heat-exchanger-system.

34. The solar steam power plant as claimed in claim 33, wherein the thermal storage system comprises a tank system containing a molten salt.
